(19) United States
(12) Patent Application Publication
(10) Pub. No.: US 2012/0319625 A1
(43) Pub. Date: Dec. 20, 2012

(54) MOTOR CONTROL SYSTEM

(75) Inventors: David G. Thomas, Peachtree City, GA (US); Hugh Boggs, JR., Sharpsburg, GA (US); Michael Twigger, Sharpsburg, GA (US)

(73) Assignee: SANY HEAVY EQUIPMENT, USA R&D INSTITUTE, Peachtree City, GA (US)

(21) Appl. No.: 13/163,518

(22) Filed: Jun. 17, 2011

(51) Int. Cl. H02P 6/04

(52) U.S. Cl. 318/51

(57) ABSTRACT

In one aspect of the present invention, a motor control system includes a rectifier module enclosed in a first flame-proof enclosure, and having a first input and one or more rectifier circuits configured to convert a first AC voltage at the first input to a DC voltage to be output to a DC bus, and one or more variable-frequency drive (VFD) modules, each VFD module being enclosed in a respective second flame-proof enclosure and having a second input coupled to the DC bus, where each VFD module includes one or more inverter circuits configured to convert the DC voltage on the DC bus to a second AC voltage to be output to one or more motors.

### FIELD OF THE INVENTION

The present invention relates to a motor control system, and more particularly, to a motor control system that utilizes the latest advances in insulated-gate bipolar transistors (IGBT) technologies for a mining equipment that allows for an AC voltage input to the equipment, converted into a DC voltage distributed bus which provides power to various IGBT pack units located in various points on the machinery.

### BACKGROUND OF THE INVENTION

Motor controls onboard mining machineries in the past have been limited to aging technologies such as contactors, motor starters and multi-speed motor control devices. These aging technologies incorporate various safety related circuits that are easy to defeat. Recent improvements utilize a variable-frequency drive (VFD) that converts a first AC voltage to a DC voltage and then to a second AC voltage. The entire VFD is usually housed in a single enclosure. The enclosure is typically large in size and is difficult to be used onboard a mining equipment where space is limited. In addition, the components of the VFD in a single enclosure may generate a large amount of heat. Also, because the devices at different voltage levels might be included in the same enclosure, noise and stray currents might be generated amongst the components.

Therefore, a heretofore unaddressed need exists in the art to address the aforementioned deficiencies and inadequacies.

### SUMMARY OF THE INVENTION

The present invention, in one aspect, relates to a motor control system. In one embodiment, the motor control system includes a rectifier module enclosed in a first flame-proof enclosure, and having a first input and one or more rectifier circuits configured to convert a first AC voltage at the first input to a DC voltage to be output to a DC bus, and one or more variable-frequency drive (VFD) modules, each VFD module being enclosed in a respective second flame-proof enclosure and having a second input coupled to the DC bus, where each VFD module includes one or more inverter circuits configured to convert the DC voltage on the DC bus to a second AC voltage to be output to one or more motors.

In one embodiment, the first AC voltage is a three-phase AC voltage, and the one or more rectifier circuits comprise three rectifier circuits, each rectifier circuit coupled to a respective phase of the first AC voltage, wherein each rectifier circuit has a full-bridge rectifier circuit. The full-bridge rectifier circuit includes four insulated-gate bipolar transistors (IGBTs).

In one embodiment, the second AC voltage is a three-phase AC voltage, and the one or more inverter circuits comprise three inverter circuits, each inverter circuit corresponding to a respective phase of the second AC voltage, wherein each inverter circuit comprises a full-bridge inverter circuit. The full-bridge inverter circuit comprises four IGBTs.

In one embodiment, the rectifier module further has a first inductor and a second inductor coupled to the one or more rectifier circuits in series and to a positive terminal and a negative terminal of the DC bus, respectively, wherein the rectifier module further comprises a filtering and energy storage circuit coupled between the positive terminal and the negative terminal of the DC bus. The filtering and energy storage circuit comprises a diode and a resistor coupled to each other in parallel, and an energy-storage capacitor coupled to the diode and the resistor in parallel via an IGBT.

In another aspect, the present invention relates to a motor control system for a mining equipment. In one embodiment, the motor control system includes a rectifier module enclosed in a first flame-proof enclosure, wherein the rectifier module has a first input and includes three rectifier circuits configured to convert a three-phase first AC voltage at the first input to a DC voltage to be output to a DC bus, each rectifier circuit coupled to a respective phase of the first AC voltage; and one or more VFD modules, each VFD module being enclosed in a respective second flame-proof enclosure and having a second input coupled to the DC bus, wherein each VFD module includes three inverter circuits configured to convert the DC voltage on the DC bus to a three-phase second AC voltage to be output to one or more motors, each inverter circuit corresponding to a respective phase of the second AC voltage.

In one embodiment, each rectifier circuit comprises a full-bridge rectifier circuit, wherein the full-bridge rectifier circuit comprises four IGBTs.

In one embodiment, each inverter circuit comprises a full-bridge inverter circuit, wherein the full-bridge inverter circuit comprises four IGBTs.

In one embodiment, the rectifier module further comprises a first inductor and a second inductor coupled to the three rectifier circuits in series and to a positive terminal and a negative terminal of the DC bus, respectively.

In another embodiment, the rectifier module further comprises a filtering and energy storage circuit coupled between the positive terminal and the negative terminal of the DC bus.

In one embodiment, the filtering and energy storage circuit comprises a diode and a resistor coupled to each other in parallel, and an energy-storage capacitor coupled to the diode and the resistor in parallel via an IGBT.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment, and wherein:

FIG. 1 shows a block diagram of a motor control system according to one embodiment of the present invention;

FIG. 2A shows a circuit diagram of a rectifier module according to one embodiment of the present invention;

FIG. 2B shows a circuit diagram of a rectifier module according to another embodiment of the present invention; and

FIG. 3 shows a circuit diagram of a variable-frequency drive (VFD) module according to one embodiment of the present invention.

### DETAILED DESCRIPTION OF THE INVENTION

The present invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, the term “plurality” means a number greater than one.

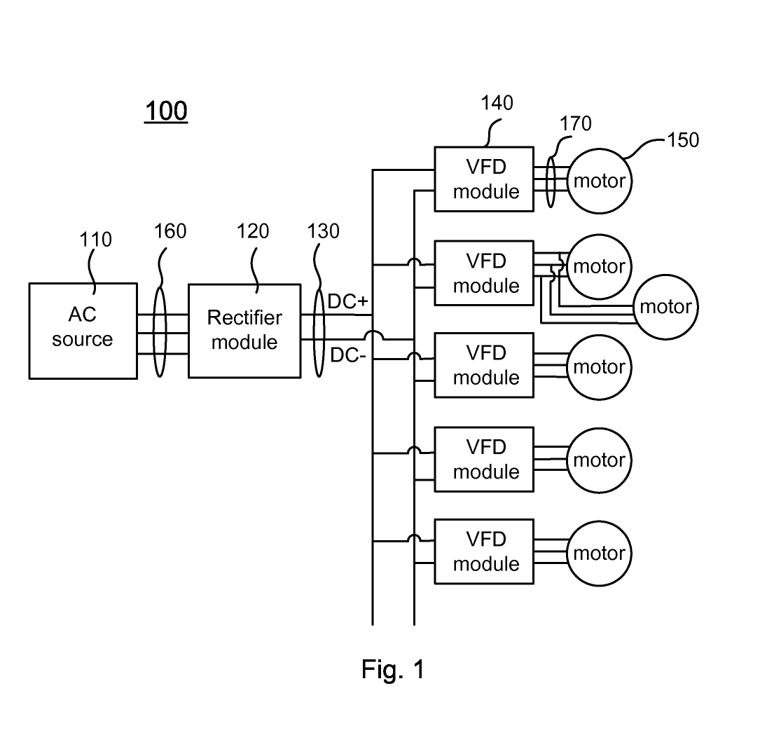

The description will be made as to the embodiments of the present invention in conjunction with the accompanying drawings in FIGS. 1-3. In accordance with the purposes of this invention, as embodied and broadly described herein, this invention, in one aspect, relates to a motor control system, also called as “maxi-motor control system”, that utilizes the latest advances in IGBT technologies for a mining equipment that allows for an AC voltage input to the equipment, changed into a DC voltage distributed bus which provides power to various small IGBT 12 pack units located in various points on the machinery. The maxi-motor control system incorporates multiple safety circuits by extensive monitoring and provides for automatic operations of the equipment based on conditions during operation protected by multi-level passwords. The advantages of the maxi-motor control system includes, among others, reducing the cable lengths to the motors minimizes the reflective wave phenomena; small individual component sizes make the installation on a mining equipment much easier; and increased flexibility by modularizing the components is gained and it is anticipated that less energy losses is realized by the use of the 12 pack power modules. The maxi-motor control system includes an inverter module, a distributed DC common bus, and multiple 12 pack power modules assembled onboard a mining equipment. These components are all located onboard the mining equipment. The distributed DC common bus is routed from the inverter module to each of the 12 pack power modules via an onboard machine cable. The 12 pack power modules are individual units for each motor and can be located near the motor in small flameproof enclosures. Refer to the following schematic embodiments of the maxi-motor control system for details.

FIG. 1 shows schematically a motor control system 100 according to one embodiment of the present invention. The motor control system 100 includes a rectifier module 120 and one or more variable-frequency drive (VFD) modules 140. The rectifier module 120 is corresponding to the inverter module, while each VFD module 140 is corresponding to a power module having 12 pack power units or insulated-gate bipolar transistors (IGBTs).

The rectifier module 120 is enclosed in a first flame-proof enclosure; and each VFD module 140 is enclosed in a respective second flame-proof enclosure. The rectifier module 120 is coupled to a power center or an AC power source 110 at an input thereof via input cables 160. The rectifier module 120 is configured to convert a first AC voltage at the input thereof to a DC voltage to be output to a common DC bus 130. The first AC voltage may be either a single-phase or a three-phase AC voltage, and may be about 110 V, or 240 V, or higher. Each VFD module 140 has an input that is coupled to the common DC bus 130, and is configured to convert the DC voltage on the DC bus 130 to a second AC voltage to be output to one or more motors 150 via output cables 170. The second AC voltage may be a single-phase or three-phase AC voltage. The frequency and the voltage of the second AC voltage are variable according to the state of the one or more motors 150.

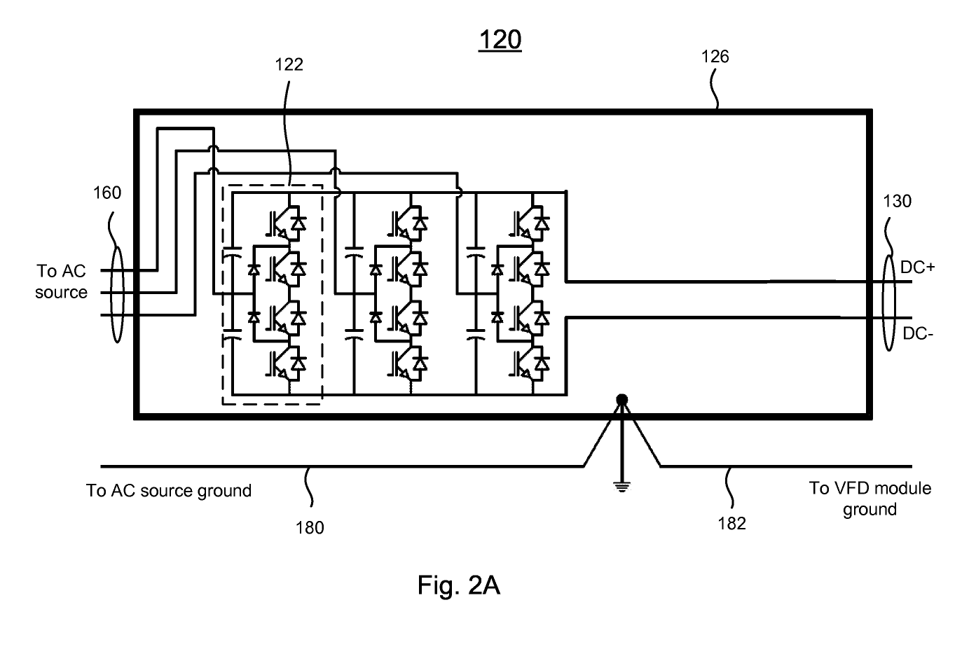

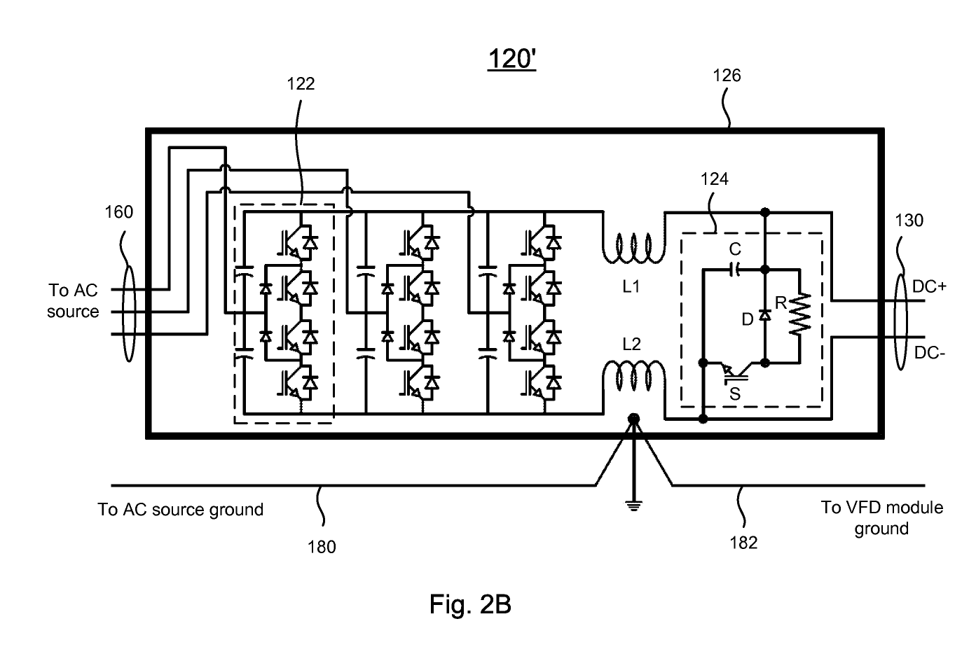

FIG. 2A shows a circuit diagram of a rectifier module 120 according to one embodiment of the present invention. The rectifier module 120 includes three full-bridge rectifier circuits 122. Each rectifier circuit 122 is coupled to a respective phase of a three-phase first AC voltage via one of the input cables 160, and comprises four IGBTs, two diodes, and two capacitors. The IGBTs act as fast and efficient switches. The rectifier module 120 is enclosed in a first flame-proof enclosure 126. The first flame-proof enclosure 126 is electrically connected to a common ground with that of the AC source via a first ground conductor 180.

FIG. 2B shows a circuit diagram of a rectifier module 120′ according to another embodiment of the present invention. The rectifier module 120′ is similar to the rectifier module 120 shown in FIG. 2A except that it further includes a first inductor L1 and a second inductor L2, and a filtering and energy-storage circuit 124. The first inductor L1 and the second inductor L2 are coupled to the three rectifier circuits in series and to a positive terminal and a negative terminal of the DC bus 130, respectively. The first inductor L1 and the second inductor L2 are included so that the current delivered to the DC bus 130 is nearly constant. The filtering and energy-storage circuit 124 is coupled between the positive terminal and the negative terminal of the DC bus 130, and comprises a diode D and a resistor R connected to each other in parallel, and an energy-storage capacitor C coupled to the diode D and the resistor R in parallel via an IGBT S.

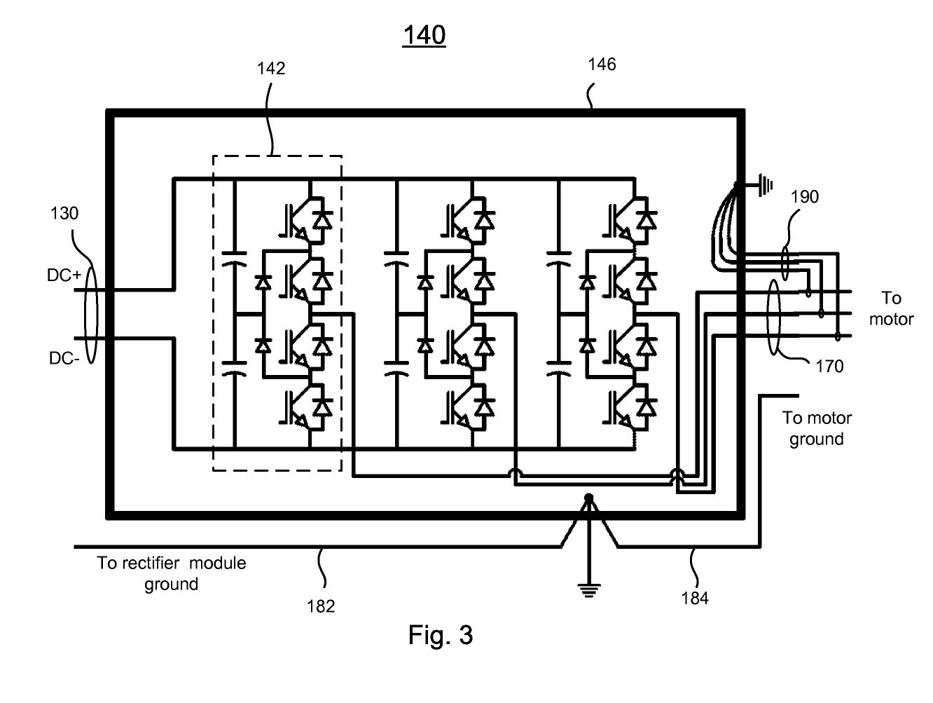

FIG. 3 shows a circuit diagram of a VFD module 140 according to one embodiment of the present invention. The input of the VFD module 140 is coupled to the rectifier module 120 via the DC bus 130. The VFD module 140 includes three inverter circuits 142 configured to convert the DC voltage on the DC bus 130 to a three-phase second AC voltage to be output to one or more motors 150 via the output cables 170. Each inverter circuit 142 corresponds to a respective phase of the second AC voltage and comprises four IGBTs, two diodes, and two capacitors. The IGBTs act as fast and efficient switches. The operation of the VFD module 140 is governed by an embedded microprocessor to provide a variable-frequency and variable-voltage quasi-sinusoidal AC power to the one or more motors 150 according to the required torque. The motor control system 100 also incorporates various safety circuits that monitor various motor conditions and provide protections to the one or more motors accordingly. The VFD module 140 is enclosed in a respective second flame-proof enclosure 146. The respective second flame-proof enclosure 146 is electrically connected to the common ground of the first flame-proof enclosure 126 of the rectifier module 120 via a second ground cable 182, and to the ground of the motor via a third ground cable 184. In addition, the shielding of the output cables 170 of the VFD module 140 are connected to the ground of the respective second flame-proof enclosure via grounding cables 190.

In summary, a motor control system 100 involving VFD technologies is described according to various embodiments. The highly controlled AC output voltage provided by the motor control system 100 allows each motor a “soft start”. The energy recovered during a regenerative braking of one motor is redistributed to another active motor via the common DC bus. In this way, energy is saved and the heat that would be generated in a conventional braking is eliminated. This is especially advantages for applications in an underground mining environment as heat could potentially cause coal dust to ignite. In addition, by putting the rectifier module 120 in a first flame-proof enclosure and each of the one or more VFD modules 140 in a separate respective second flame-proof enclosure, the size of each flame-proof enclosure and the heat generated in it can both be minimized. This modular approach affords increased flexibility and ease of installation on a mining equipment. By positioning the one or more VFD modules 140 at various points on the mining equipment close to the corresponding motors 150, the cable length between each VFD module 140 and a respective motor 150 can be made relatively short and reflective wave phenomena can be minimized. Furthermore, because devices for different voltage levels are enclosed in separate enclosures, noise and stray currents are minimized.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A motor control system, comprising:
(a) a rectifier module enclosed in a first flame-proof enclosure, wherein the rectifier module has a first input and includes one or more rectifier circuits configured to convert a first AC voltage at the first input to a DC voltage to be output to a DC bus; and
(b) one or more variable-frequency drive (VFD) modules, each VFD module being enclosed in a respective second flame-proof enclosure and having a second input coupled to the DC bus, wherein each VFD module includes one or more inverter circuits configured to convert the DC voltage on the DC bus to a second AC voltage to be output to one or more motors.

2. The motor control system of claim 1, wherein the first AC voltage is a three-phase AC voltage, and the one or more rectifier circuits comprise three rectifier circuits, each rectifier circuit coupled to a respective phase of the first AC voltage.

3. The motor control system of claim 2, wherein each rectifier circuit comprises a full-bridge rectifier circuit.

4. The motor control system of claim 3, wherein the full-bridge rectifier circuit comprises four insulated-gate bipolar transistors (IGBTs).

5. The motor control system of claim 1, wherein the second AC voltage is a three-phase AC voltage, and the one or more inverter circuits comprise three inverter circuits, each inverter circuit corresponding to a respective phase of the second AC voltage.

6. The motor control system of claim 5, wherein each inverter circuit comprises a full-bridge inverter circuit.

7. The motor control system of claim 6, wherein the full-bridge inverter circuit comprises four IGBTs.

8. The motor control system of claim 1, wherein the rectifier module further comprises a first inductor and a second inductor coupled to the one or more rectifier circuits in series and to a positive terminal and a negative terminal of the DC bus, respectively.

9. The motor control system of claim 8, wherein the rectifier module further comprises a filtering and energy storage circuit coupled between the positive terminal and the negative terminal of the DC bus.

10. The motor control system of claim 9, wherein the filtering and energy storage circuit comprises a diode and a resistor coupled to each other in parallel, and an energy-storage capacitor coupled to the diode and the resistor in parallel via an IGBT.

11. A motor control system for a mining equipment, comprising:
(a) a rectifier module enclosed in a first flame-proof enclosure, wherein the rectifier module has a first input and includes three rectifier circuits configured to convert a three-phase first AC voltage at the first input to a DC voltage to be output to a DC bus, each rectifier circuit coupled to a respective phase of the first AC voltage; and
(b) one or more VFD modules, each VFD module being enclosed in a respective second flame-proof enclosure and having a second input coupled to the DC bus, wherein each VFD module includes three inverter circuits configured to convert the DC voltage on the DC bus to a three-phase second AC voltage to be output to one or more motors, each inverter circuit corresponding to a respective phase of the second AC voltage.

12. The motor control system of claim 11, wherein each rectifier circuit comprises a full-bridge rectifier circuit.

13. The motor control system of claim 12, wherein the full-bridge rectifier circuit comprises four IGBTs.

14. The motor control system of claim 11, wherein each inverter circuit comprises a full-bridge inverter circuit.

15. The motor control system of claim 14, wherein the full-bridge inverter circuit comprises four IGBTs.

16. The motor control system of claim 11, wherein the rectifier module further comprises a first inductor and a second inductor coupled to the three rectifier circuits in series and to a positive terminal and a negative terminal of the DC bus, respectively.

17. The motor control system of claim 16, wherein the rectifier module further comprises a filtering and energy storage circuit coupled between the positive terminal and the negative terminal of the DC bus.

18. The motor control system of claim 17, wherein the filtering and energy storage circuit comprises a diode and a resistor coupled to each other in parallel, and an energy-storage capacitor coupled to the diode and the resistor in parallel via an IGBT.
